(19) United States
(12) Patent Application Publication
(10) Pub. No.: US 2024/0192084 A1
(43) Pub. Date: Jun. 13, 2024

(54) TEST BENCH FOR SNUBBER

(71) Applicant: MINETEC S.A., Santiago (CL)

(72) Inventors: Bernardo Luis VERA TORRES, Santiago (CL); Claudio Devon ZAMORANO JONES, Santiago (CL)

(73) Assignee: MINETEC S.A., Santiago (CL)

(21) Appl. No.: 18/530,549

(22) Filed: Dec. 6, 2023

(30) Foreign Application Priority Data
Dec. 7, 2022 (CL) 202203481

(51) Int. Cl. G01M 13/00

(52) U.S. Cl. CPC G01M 13/00

(57) ABSTRACT

A test bench to evaluate the operation of a brake or shock absorber for bucket doors of excavators or electric shovels that allows simulating real operating conditions of the bucket doors, which includes a brake support that allows installing and fixing the brake to be evaluated, said brake comprising, a body with an axis that is connected to the end of an arm in a pivotal manner and its other end is used for connection with the bucket door; a pendulum to simulate the loads received by the brake due to the opening and/or closing movement of the bucket door, comprising a pendulum arm comprising an upper end with a lateral edge comprising at least one opening to be fixedly connected to the free end of the brake arm, an inner side pivotally connected to a pendulum support, arranged in front of the brake support, allowing rotational movement of the pendulum, and an outer side comprising a plurality of openings defining a predefined inclination; and a lower end comprising a known mass; a locking device on one side of the upper end of the pendulum arm, which allows an inclination position of the pendulum arm to be fixed; a support structure, on which the rest of the elements of said test bench are installed or arranged; and a plurality of sensors that allow measurements of at least the pressure in the brake chambers, the temperature of the fluid in the brake chambers, and the angular velocity and acceleration of the pendulum and brake arm.

### CROSS-REFERENCE TO RELATED APPLICATIONS

This application claims priority to Chilean Patent application No. CL 202203481, filed Dec. 7, 2022, the entire contents of which are incorporated herein by reference.

### TECHNICAL FIELD

The invention is developed in the field of apparatus and devices for carrying out tests on machine parts and/or mechanical elements, specifically, it refers to a test bench to evaluate the operation of a brake or shock absorber for bucket doors of excavators or shovels. electric that simulates real operating conditions of bucket doors.

### DESCRIPTION OF PREVIOUS ART

Currently, there are hydraulic test benches that evaluate the operating capacity of bucket door brakes on excavators or electric shovels. In these test benches, a hydraulic cylinder is used to apply a load to the brake to simulate the opening and/or closing movement of the bucket door, such as the one shown in FIG. 1, which work as follows: A hydraulic fluid enters the hydraulic cylinder (1) at one end, this produces a linear displacement of the stem (2) connected to the brake arm (3). As a result of this displacement, the brake axis (4) rotates.

This type of test bench has drawbacks that occur when measuring the capacities of a brake in operation; they do not translate in the best way because the shock absorbers operate at high speeds and loads, where they can recreate the energy produced by the brake cap. bucket has a high cost so the power required to simulate a proper brake performance test is not achieved.

On the other hand, hydraulic cylinders are usually used to apply a force through a linear path at a constant speed, which differs from the pendulum movement produced by the bucket door during opening or closing with a hydraulic cylinder. The pendulum or pendulum movement describes a circular path with a variable speed, which means that the force changes along the way, so replicating said movement with a linear path or displacement, at a constant speed, is not acceptable due to because the physical conditions vary during the pendulum path, so it does not represent the movement of an opening and/or closing of the lid.

In the state of the art, different test benches can be found to evaluate the operating capacity of the brakes, among which the document KR20110096018 can be cited, which describes a portable device to test a brake or shock absorber and a test method to verify the brake or damper performance, however, does not refer to a brake or damper for bucket doors, but rather to a damper attached to an industrial pipe.

In this way, the prior art does not teach a test bench to evaluate the operation of a brake or shock absorber for bucket doors of excavators or electric shovels that allows simulating or reproducing, in a better way, the real operating conditions of bucket doors. buckets.

### DESCRIPTION OF THE INVENTION

The invention relates to a test bench to evaluate the operation of a brake or shock absorber for bucket doors of excavators or electric shovels that allows simulating real operating conditions of the bucket doors. The test bench works through the potential energy stored by bringing a known mass up to a certain inclination, above a horizontal reference level.

The brake or shock absorber corresponds to a mechanical element, such as a snubber, typically used in the bucket doors of excavator shovels or electric shovels that is responsible for braking and/or cushioning the bucket door when it is opened and/or closed. The brake, commonly, is composed of a chamber located within a circular body with a mounting foot and perforations that allow its mounting on an excavator shovel, where said body has circular side plates, an axis that crosses the chamber and extends to through one of the circular side plates connecting on the outside of the body to an arm that is connected to the bucket door by means of a hooking ear or any other type of suitable connection element, allowing a pivotal movement to be printed on said axis with respect to the circular body. The example is rotatably mounted to the circular side plates by means of bearings. The chamber has inside a vane mounted integrally on the axis, the vane being slidably coupled as a seal with respect to the circular side plates and said vane having a sealing surface. Inside the chamber there is also a vane blade that extends from the inner surface of the circular body to the sealing surface between the circular side plates. The vane and the vane blade divide the chamber into a first sub-chamber and a second sub-chamber. The chamber includes a hydraulic fluid inside that flows between the sub-chambers during brake operation, where the passage of fluid between said sub-chambers is controlled to control the opening or closing speed of the bucket door of the excavator shovel.

The test bench comprises a brake support that allows the brake to be evaluated to be installed and fixed, said brake comprising a body with an axis that is connected to the end of an arm in a pivotal manner and its other end is used for connection with the bucket door; a pendulum to simulate the loads received by the brake due to the opening and/or closing movement of the bucket door, comprising a pendulum arm comprising an upper end with a lateral edge comprising at least one opening to be fixedly connected to the free end of the brake arm, to represent a configuration of installing the brake in the bucket door, an inner side pivotally connected with a pendulum bracket, arranged in front of the brake bracket, allowing rotational movement of the pendulum, and an outer side comprising a plurality of openings defining a predefined inclination with respect to a horizontal surface; and a lower end comprising a known mass representing the bucket door; a locking device, arranged in the same plane as the brake support and the pendulum support, on one side of the upper end of the pendulum arm, which makes it possible to fix an inclination position of the pendulum arm, comprising a latch that engages in an opening of the plurality of openings of the pendulum arm; and a hydraulic system connected to the latch, moving it linearly, to engage or remove said latch from an opening of the plurality of openings; a support structure, on which the rest of the elements of said test bench are installed or arranged, being formed by beams that define a support or vertical legs that support the test bench and a horizontal support on which the brake support, the pendulum support and the insurance device, where the horizontal support has an open section that allows the rotational movement of the pendulum; and a plurality of sensors that allow real-time measurements to be obtained of at least the pressure in the brake chambers, the temperature of the fluid in the brake chambers, and the angular velocity and acceleration of the pendulum and brake arm.

The test bench according to the present invention operates as follows: the brake to be evaluated is installed on the test bench, connecting the brake arm to the upper end of the pendulum arm, in front of the brake, then a known mass, at the lower end of the pendulum arm, it is brought to a determined inclination by means of a lifting system. When the determined inclination is reached, the position of the mass is momentarily secured by the locking device that blocks the movement of the pendulum arm. To begin the test, the insurance device is removed by the hydraulic system, generating the potential energy stored due to the inclination of the mass to be transformed into kinetic energy, initiating the rotation or rotational movement of the brake shaft, emulating or replicating the movement. of the bucket door during its opening and/or closing.

This test bench allows the generation of real operating conditions since it allows applying loads on the brake that are not restricted to changes or displacement in a linear direction. The use of a mass that moves in a pendulum movement allows different configurations of counterweights to be generated, making it possible to modify said mass by increasing or decreasing it depending on the weight of a door whose operation needs to be evaluated or simulated. In addition, the test bench allows defining multiple initial potential energy storage conditions to evaluate the brake at different operating conditions.

### BRIEF DESCRIPTION OF THE FIGURES

The accompanying figures are included to provide a greater understanding of the invention and constitute part of this description, and also illustrate preferred embodiments of the invention, where it is seen that:

FIG. 1 shows a test bench for bucket door brakes of excavators or electric shovels according to the prior art.

FIG. 2A shows a side view of a test bench for bucket door brakes of excavators or electric shovels, according to one embodiment of the invention.

FIG. 2B shows a front view of a test bench for bucket door brakes of excavators or electric shovels, according to one embodiment of the invention.

FIG. 3A shows the position of accelerometers on the brake arm and pendulum arm, according to one embodiment of the invention.

FIG. 3B shows the position of pressure transducers in test manifold in the brake body and the position of temperature sensors in test manifold in the brake body and in the back of the brake body, according to one embodiment of the invention.

FIG. 3C shows the position of a pendulum position sensor in the connection area between the pendulum and the pendulum support, according to one embodiment of the invention.

FIG. 3D shows the position of a pendulum inclination sensor in the insurance device, according to one embodiment of the invention.

FIG. 3E shows the position of a latch stroke sensor in the locking device, according to one embodiment of the invention.

FIG. 4A shows a side view of a test bench for bucket door brakes of excavators or electric shovels according to an alternative embodiment of the invention that includes a lifting assembly to raise the mass.

FIG. 4B shows a front view of a test bench for bucket door brakes of excavators or electric shovels according to an embodiment of the invention that includes a lifting assembly to raise the mass.

FIG. 4C shows a partial view of the rear part of the lifting assembly of a test bench for bucket door brakes of excavators or electric shovels according to one embodiment of the invention.

FIG. 4D shows a partial view of the connection between the lifting assembly and the pendulum of the test bench for bucket door brakes of excavators or electric shovels according to one embodiment of the invention.

FIG. 4E shows the position of cylinder stroke sensors in a hydraulic system for raising mass, according to one embodiment of the invention.

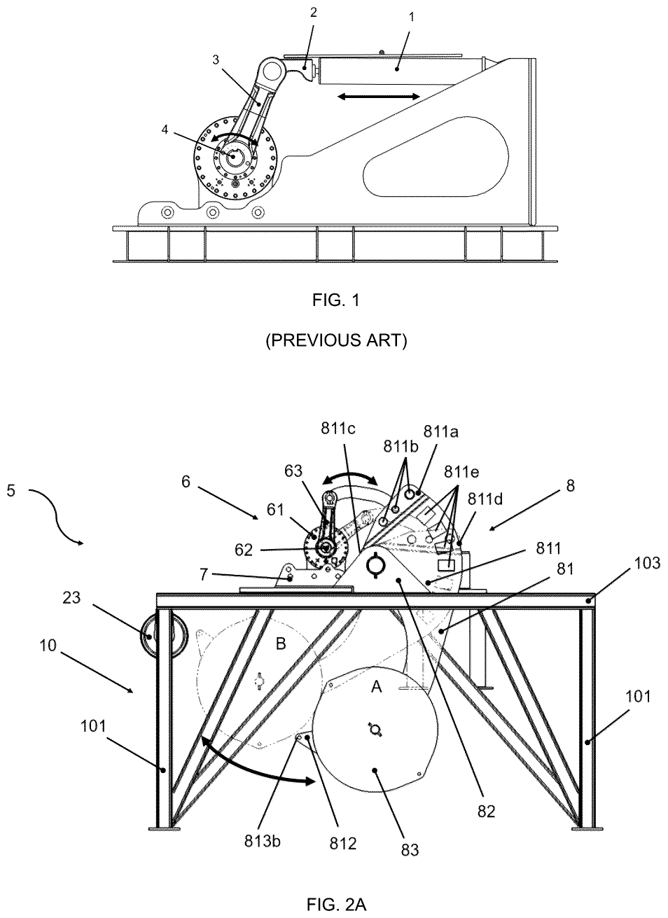

### DETAILED DESCRIPTION OF THE INVENTION

The invention refers to a test bench (5) to evaluate the operation of a brake (6) or shock absorber for bucket doors of excavators or electric shovels that allows simulating real operating conditions of the bucket doors. The test bench (5) works through the stored potential energy by bringing a known mass up to a certain inclination, above a horizontal reference level.

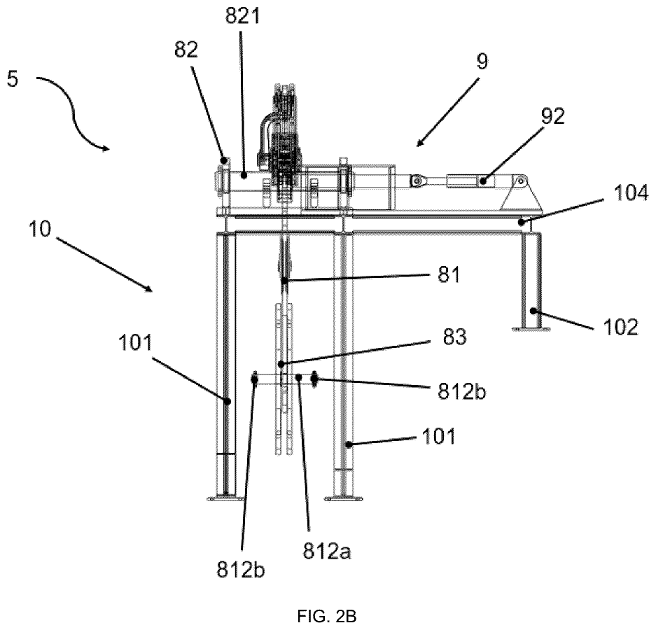

The test bench (5), as shown in FIGS. 2A and 2B, comprises a brake support (7) that allows installing and fixing the brake (6) to be evaluated, said brake (6) comprising, a body (61) with a shaft (62) that is connected to the end of an arm (63) in a pivotal manner and its other end is used for connection with the bucket door; a pendulum (8) to simulate the loads received by the brake (6) due to the opening and/or closing movement of the bucket door, comprising a pendulum arm (81) comprising an upper end (81) with an edge side (811a) comprising at least one opening (811b) to be fixedly connected to the free end of the arm (63) of the brake (6), to represent an installation configuration of the brake (6) in the bucket door, an inner side (811c) pivotally connected with a pendulum support (82), by means of a shaft (821), arranged behind the brake support (7), allowing the rotational movement of the pendulum (8), and an outer side (811c) (811d) comprising a plurality of openings (811e) that define a predefined inclination of the pendulum (8) with respect to a horizontal surface; and a lower end (812) comprising a known, interchangeable mass (83) representing the load due to the weight of the bucket door; a safety device (9), arranged in the same plane as the brake support (7) and the pendulum support (82), on one side of the upper end (811) of the pendulum arm (81), which engages in an opening of the plurality of openings (811e) on the outer side (811d) of the pendulum arm (81), to set an inclination position of the pendulum arm (81), which defines an initial potential energy storage condition, when placed in an opening of the plurality of openings (811e), said locking device (9) comprising a latch (91) that fits into an opening of the plurality of openings (811e) on the outer side (811d) of the arm pendulum (81); and a hydraulic system (92) connected to the latch (91), which allows the actuation of said latch (91) for its linear movement to engage or remove said latch (91) from an opening of the plurality of openings (811e) on the side exterior (811d) of the pendulum arm (81); a support structure (10), on which the rest of the elements of said test bench (5) are installed or arranged, being formed by beams that define a support or vertical legs that support the components of the test bench (5), and horizontal supports on which the brake support (7), the pendulum support (82) and the insurance device (9) are arranged, where the horizontal supports have an open section that allows the rotational movement of the pendulum (8); and a plurality of sensors that allow obtaining measurements, in real time, of at least the pressure in the brake chambers (6), the temperature of the fluid in the brake chambers (6), and the angular velocity and acceleration of the pendulum (8) and arm (63) of the brake (6).

The horizontal supports comprise a first horizontal support (103) that supports the brake support (7) and the pendulum support (82), and include an open section that allows rotational movement of the pendulum (8); and a second horizontal support (104) projecting from a side of the first horizontal support (103) to support the locking device (9). The vertical supports comprise a first vertical support (101) which is connected to and supports the first horizontal support (103) on which the brake support (7) and the pendulum support (82) are arranged; and a second vertical support (102) that is located on one side of the first vertical support (101), being connected to the second horizontal support (104), said second vertical support (104) being connected to the end of said horizontal support (104). 104). In one embodiment, the vertical supports (101, 102) can have a different length, adjusting to the installation location of the test bench (5).

The arm (63) of the brake (6) is formed by a first arm section and a second arm section, where one end of the first arm section is pivotally connected to the shaft (62) of the brake (6). and one end of the second arm section is configured for connection with the bucket, being connected in the test bench (5) to the at least one opening (811b) of the lateral edge (811a) of the upper end (811) of the pendulum arm (81), where the other end of the first arm section and the second arm section are pivotally connected to each other to follow the movement of the bucket door and, in this case, the pendulum (81). 8) of the test bench (5).

In one embodiment, the upper end (811) of the pendulum arm (81) is shaped like a circumference section where the side edge (811a) corresponds to a radius of the circumference section that includes a flange comprising at least one opening. (811b), the inner side (811c) is defined by the area where the radii of the circumference section join, where a circular opening is included to place the axis (821) of the pendulum support (82) and connect said upper end (811) pivotally with said pendulum support (82) allowing the rotational movement of the pendulum (8), and the outer side (811d) corresponds to the arc of the circumference section where the plurality of openings (811e) They are regularly separated from each other by an equiangular distance near the arc of the circumference section.

In one embodiment, the lower end (812) of the pendulum arm (81) comprises a first perforation in which a bar (812a) is arranged, the ends of which protrude from each side of said lower end (812), which allows placing the mass (83) that represents the load due to the weight of the bucket door; and an adjustable lock (812b) at each end of the bar to secure the position of the mass (83). The mass (83) can be formed by a set of interchangeable masses of different weight to facilitate its installation at the lower end (812) and favor the arrangement of different counterweight configurations according to the bucket door that is required to be represented, said set comprising of masses at least two elements of the same mass arranged at each end of the bar (812a). In one embodiment, the mass (83) or the mass assembly is disc-shaped, such that the mass assembly comprises at least two discs. The lower end (812) may also comprise a second perforation (812c) to connect with an auxiliary lifting system to position the pendulum (8) up to a determined inclination.

In one embodiment, the hydraulic system (92) of the insurance device (9) corresponds to a hydraulic cylinder that includes a rod connected to the latch (91) so that when said hydraulic cylinder is activated, a linear displacement of the latch (91) is produced. 91) to engage or remove said latch (91) from an opening of the plurality of openings (811e) on the outer side (811d) of the pendulum arm (81).

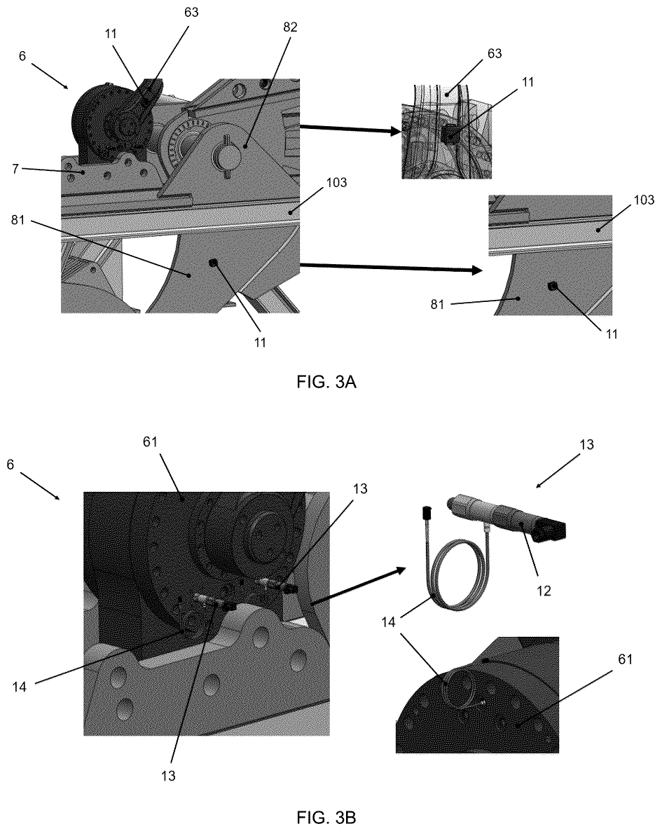

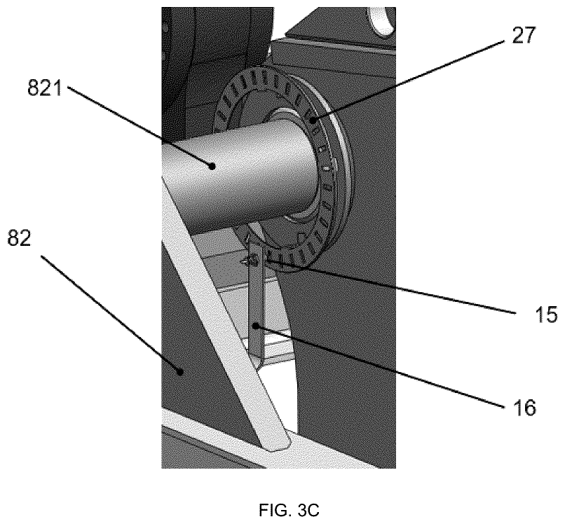

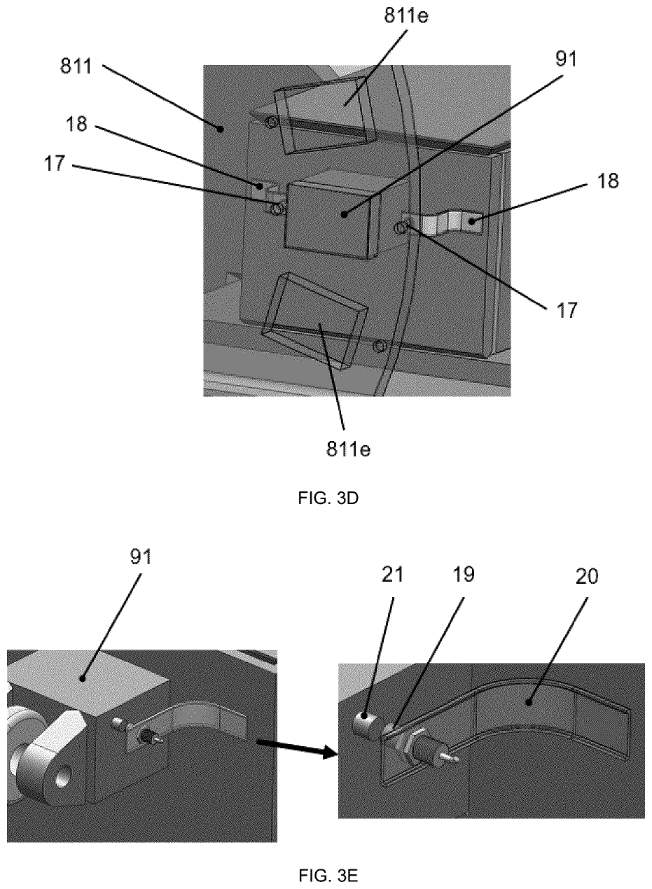

The plurality of sensors comprises at least one accelerometer (11) mounting on the arm (63) of the brake (6), as shown in FIG. 3A, which includes an angle inclinometer, gyroscope and magnetometer to measure acceleration, angular velocity and position. of the arm (63) of the brake (6); a pressure transducer (12) mounted on each test manifold (13) arranged in the body (61) of the brake (6), in a position as indicated in FIG. 3B, to measure the gauge pressure in the interior chambers of the body (61) of the brake (6); at least one temperature sensor (14) mounted on each test manifold (13) and on the back of the body (61) of the brake (6), as shown in FIG. 3B, to measure the temperature in the fluid in the cameras of said body (61); and at least one pendulum tilt sensor mounted on the pendulum (8) to measure the acceleration, angular velocity and position of the pendulum (8) or the pendulum arm (81).

In one embodiment, the accelerometers (11) are digital sensors that can be connected wirelessly or via cables and include a data storage memory card and battery; the pressure transducer (12) is an analog sensor with a measurement range of 0 to 250 bar; and the temperature sensor (14) is a thermocouple or an analog or digital sensor such as a resistance thermometer.

In one embodiment, the at least one pendulum inclination sensor corresponds to at least one accelerometer (11) mounted on the pendulum arm (81), as shown in FIG. 3A, which includes an angle inclinometer, gyroscope and magnetometer to measure the acceleration, angular velocity and position of the pendulum arm (81); a pendulum position sensor (15), mounted on a support (16) fixed to the pendulum support (82) as shown in FIG. 3C, which records the position of the pendulum (8); or a combination of these. In one embodiment, the pendulum position sensor (15) corresponds to a Hall effect sensor that uses a coded disk (27) mounted on the shaft (821) of the pendulum support (82), which comprises an optical pattern that is electronically decodes to generate position information of the pendulum (8), specifically, the coding disk (27) comprises a plurality of slots arranged in an orderly manner and regularly separated by an angle, being arranged near the edge of the coding disk (27) throughout. its perimeter, so that the pendulum position sensor (15) detects the transitions between the slots and the parts of the coded disk (27) to obtain information on the position of the pendulum and determine the acceleration, angular velocity and position of the pendulum (8).

The plurality of sensors may further comprise two pendulum inclination sensors (17) each mounted on a support (18) fixed to the locking device (9) on each side of the latch (91), as shown. FIG. 3D, which records the inclination of the pendulum (8) based on proximity switches placed in the plurality of openings (811e) on the outer side (811d) of the upper end (811) of the pendulum arm (81), which allows the position of each opening of the plurality of openings (811e) to be determined so that the locking device (9) is securely engaged to fix the position of the pendulum (8) and the mass (83) at the desired inclination or required. In one embodiment, the pendulum inclination sensor (17) and the proximity switches are of the inductive type.

Furthermore, the insurance device (9) comprises a stroke sensor that makes it possible to determine its position with respect to an opening of the plurality of openings (811e) on the outer side (811d) of the pendulum arm (81) to verify whether the insurance device The lock (9) is correctly positioned in said opening of the plurality of openings (811e) to fix an inclination position of the pendulum arm (81). In one embodiment, the locking device (9) comprises a latch stroke sensor (19) to determine the position and stroke end of the latch (91). The latch stroke sensor (19) is arranged at the end of a support (20) in the locking device (9) so that it faces a lateral side of the latch (91), where, in an initial position, the latch stroke sensor (19) faces a detection point or plate (21) arranged on the lateral side of the latch (91), as shown in FIG. 3E. The latch stroke sensor (19) allows the position of the latch (91) to be determined, depending on the distance between it and the detection point or plate (21), sending an output signal. In one embodiment, the latch stroke sensor (19) is of the inductive type, being an inductive proximity switch.

The sensors in the test bench (5) are in communication with a control panel or control center (22) that allows the measurements made to be processed and recorded and the value of the corresponding variables displayed in real time. The measurements and results obtained are saved, for example, as a data sheet, and reported for subsequent analysis. They can be reported in real time or at the end of a test or braking cycle either through a screen on or connected to the control center (22) or by means of a voucher printed by the control center (22).

The test bench (5) according to the described modality operates as follows: the brake (6) to be evaluated is installed on the test bench (5), connecting the arm (63) of the brake (6) to the end upper (811) of the pendulum arm (81), behind the brake (6), and a plurality of sensors are installed in the brake (6) and pendulum arm (81) to measure, in real time, at least the pressure in brake chambers (6), the temperature of the fluid in the brake chambers (6), and the angular velocity and acceleration of the pendulum (8) and arm (63) of the brake (6). Then the pendulum (8), with the mass (83) is brought to a desired or required inclination for the test, for example, from a position (A) to a position (B), as shown schematically in FIG. 2A, said inclination being defined by the plurality of openings (811e) on the outer side (811d) of the upper end (811) of the pendulum arm (81); When the desired or required inclination is reached, the position of the pendulum (8) is secured by placing the insurance device (9) in the corresponding opening of the plurality of openings (811e), blocking the movement of the pendulum (8); To start the test, the insurance device (9) is removed from the corresponding opening, generating the potential energy stored due to the inclination of the mass (83) to be transformed into kinetic energy, initiating the rotation or rotational movement of the axis of the brake (62) of the brake (6), through the arm (63) of the brake (6), emulating the movement of the bucket door during its opening and/or closing. Finally, the measurements made by the plurality of sensors are transmitted to a control panel or control center (22) for processing and recording. The measurements can be stored as a data sheet or reported in real time or at the end of a test or braking cycle either through a screen on or connected to the control center (22) or through a voucher printed by the control center. control (22).

The mass (83) is previously placed at the lower end of the pendulum arm (81) depending on the load to which the brake (6) would be subjected for a particular bucket door.

The position of the pendulum (8) is ensured by placing the latch (91) of the insurance device (9) in the corresponding opening of the plurality of openings (811e), being actuated by the hydraulic system (92) of the insurance device (9).). Likewise, to remove the insurance device (9) and start the test, the hydraulic system (92) is activated to remove the latch (91) and start the movement of the pendulum (8), transforming the potential energy into kinetic energy by rotating the shaft (62) of the brake (6), through the arm (63) of the brake (6), emulating the movement of the bucket door during its opening and/or closing. The braking test or cycle ends when the brake (6) dissipates the energy released by the pendulum (8). To perform another braking test or cycle, the same procedure described above must be carried out.

The mass (83) can be brought to a desired or required inclination for the test by means of a lifting system. In one embodiment, the lifting system corresponds to a hoist located in the upper area of the test bench (5), which passes through a pulley (23) arranged in the front part of the support structure (10), being aligned with the position of the pendulum (8) and at a higher height than the mass (83) to carry the mass (83), for example, from a position (A) to a position (B).

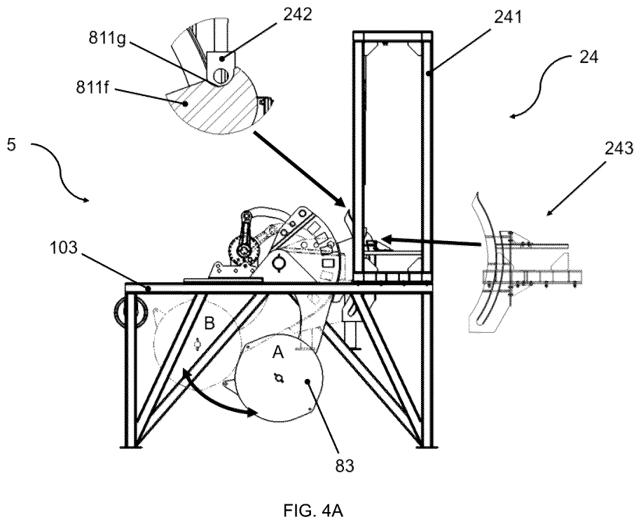

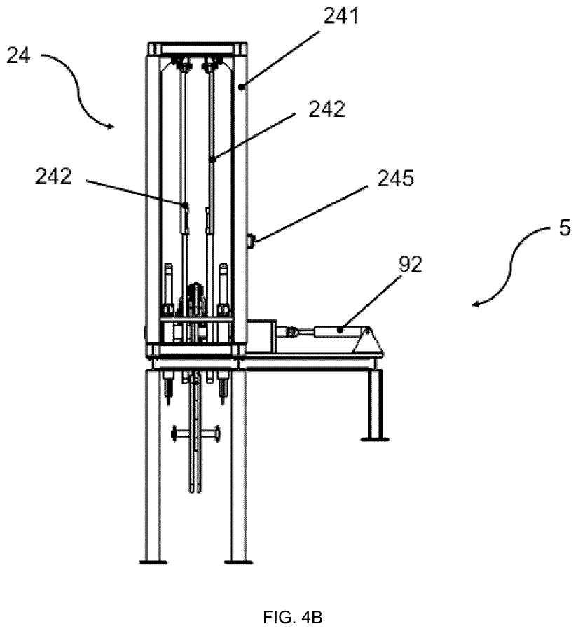

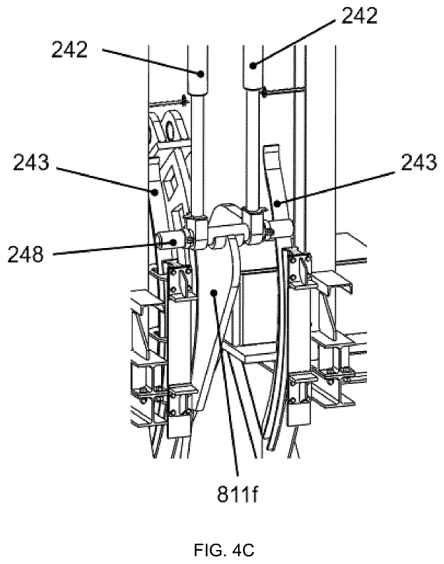

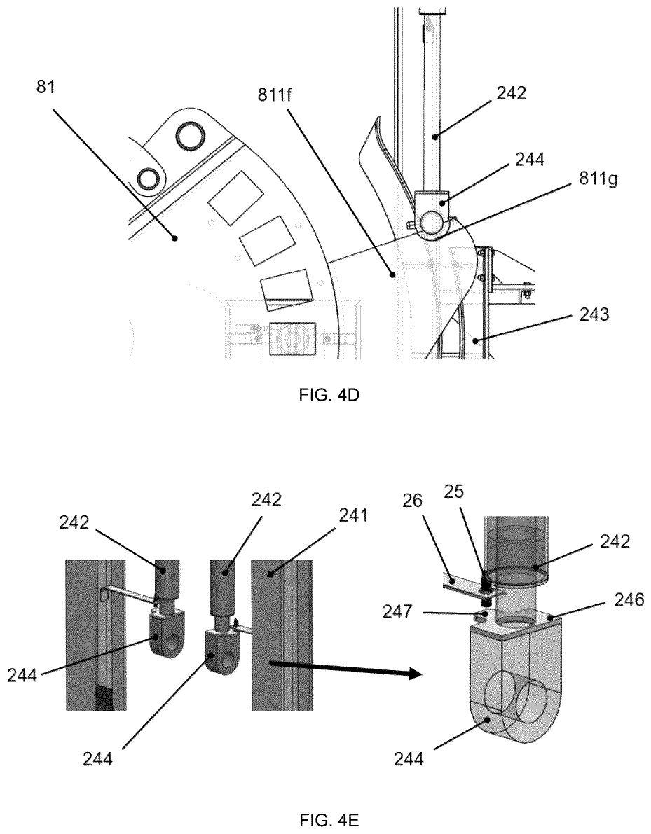

In one embodiment, the test bench (5) comprises a lifting assembly (24) for raising the mass (83), arranged at the rear of the support structure (10), on the first horizontal support (103), behind the brake support (7) and the pendulum support (82), as shown in FIGS. 4A and 4B. The lifting assembly (24) comprises a structure (241) formed by beams that form a frame that extends vertically over the first horizontal support (103); a hydraulic system supported vertically on the structure (241) comprising at least one hydraulic cylinder (242) that descends to come into contact with the pendulum (8) and raise the mass (83) to a required inclination; a guide (213) arranged in the lower part of the structure (241), so that the at least one hydraulic cylinder follows the path of the pendulum (8) when the mass (83) is raised. In one embodiment, the guide (213) is arranged on the first vertical support (103). The at least one hydraulic cylinder (242) is arranged vertically, being pivotally fixed in the upper part of the structure (241) by its fixed end and, its mobile end, defined by the stem and eye of the stem (244), It is configured to move vertically to contact the pendulum (8) to raise the mass (83). The at least one hydraulic cylinder (242) descends to contact the pendulum (8) and raise the mass (83), where the pivoting connection of the at least one hydraulic cylinder allows its inclination to follow the path of the pendulum (8). In one embodiment, the guide (213) comprises two equal plates arranged separately from each other on each lateral side of the structure (241) that include a slot that follows the path of the pendulum when the mass (83) is raised, where the al At least one hydraulic cylinder has an axle (248) connected to the eye of the rod (244), as shown in FIG. 4C, the ends of which each fit into a slot in the guide plates (213) when the system hydraulic descends to contact the pendulum (8) and raise the mass (83). In one embodiment, when the hydraulic system comprises two or more hydraulic cylinders (242), the respective rod eyes (244) can be connected to each other by the shaft (248) to descend in alignment and contact the pendulum (8) to raise the mass (83).

In one embodiment, the pendulum (8) further comprises an extension (811f), as shown in FIGS. 4A and 4D, which projects from its outer side (811d) that comprises a crescent connection (811g) that adjusts to the shape of the eye of the stem (244) of at least one hydraulic cylinder (242), so that the hydraulic system of the lifting assembly (24) can raise the mass (83) when said eye of the stem (244) engages at the crescent connection (811g) when moving vertically downward. The crescent connection (811g) corresponds to a projection in the extension (811f) that allows at least one eye of the stem (244) to fit.

In one embodiment, the hydraulic system comprises two or more hydraulic cylinders (242) being arranged vertically, separated from each other, and fixed to the upper part of the structure (241) by its fixed end and its mobile end, defined by the rod. and eye of the rod (244), is configured to move vertically to contact the pendulum (8) to raise the mass (83) so that said hydraulic cylinders (242) descend in an aligned manner, being connected to each other by an axis (248), to contact the pendulum (8) and raise the mass (83).

In this embodiment, the crescent connection (811g) of the extension (811f) of the outer side (811d) of the pendulum arm (81) conforms to the shape of an eye of the rod (244) of a hydraulic cylinder (242). or of the shaft (248) that connects the eyes of the stem (244) of the hydraulic cylinders (242), so that the hydraulic system of the lifting assembly (24) can raise the mass (83) when said shaft (248) is It fits into the crescent connection (811g) when the hydraulic cylinders (242) move vertically downward, as shown in FIG. 4C. The crescent connection (811g) corresponds to a protrusion in the extension (811f) that allows the eye of the rod (244) of a hydraulic cylinder or the shaft (248) that connects the eyes of the rod (244) of the hydraulic cylinders to fit. (242).

The hydraulic system of the lifting assembly (24) allows the mass (83) to be raised to a desired or required inclination, for example, from a position (A) to a position (B), as shown schematically in FIG. 4A, to then secure the position of the pendulum (8) by placing the latch (91), of the insurance device (9), in the corresponding opening of the plurality of openings (811e) on the outer side (811d) of the upper end (811) of the pendulum arm (81). Once the position of the pendulum (8) is set, the hydraulic system is disconnected to return to its initial position in the lifting assembly (24).

In one embodiment, the hydraulic system is controlled by a button panel (245) that allows activating/deactivating the hydraulic cylinders (242) to contact the pendulum (8) and raise the mass (83) or remove said hydraulic cylinders (242) from the pendulum (8), to return to its initial position.

In this mode, when the test bench (5) includes a lifting assembly (24), the start of a test or braking cycle in this mode is equivalent to what was previously described, where the latch (91) is removed by the hydraulic system (92) to initiate the movement of the pendulum (8), transforming the potential energy into kinetic energy by rotating the shaft (62) of the brake (6), through the arm (63) of the brake (6), emulating the movement of the bucket door during its opening and/or closing. The braking test or cycle ends when the brake (6) dissipates the energy released by the pendulum (8).

The lifting assembly (24) may also comprise a cylinder stroke sensor (25), for each hydraulic cylinder (242) of the hydraulic system, to determine the position and stroke end of each hydraulic cylinder (242) of the system. hydraulic lift assembly (24). The cylinder stroke sensor (25) is arranged at the end of a support (26) fixed or attached to the structure (241) of the lifting assembly (24) so that the cylinder stroke sensor (25) points to the eye of the rod (244) of the respective hydraulic cylinder (242), being at a height in the structure (241) so that the cylinder stroke sensor (25) is close to the back of the eye of the rod (244) when The respective hydraulic cylinder (242) is in a retracted or contracted position, as shown in FIG. 4E. The cylinder stroke sensor (25) allows the position of the stem eye (244) to be determined, depending on the distance between said cylinder stroke sensor (25) and the back of the stem eye (244), sending an exit sign. In one embodiment, the cylinder stroke sensor (25) is of the inductive type, being an inductive proximity switch. In one embodiment, each hydraulic cylinder (242) of the hydraulic system comprises a plate (246) at the rear of the eye of the rod (244) that includes a flange-shaped projection (247) at which the pressure sensor points. respective cylinder stroke (25), facilitating the detection of the position of the eye of the stem (244) to determine the distance traveled by it.

In one embodiment, the hydraulic system (92) of the insurance device (9) and the hydraulic system of the lifting assembly (24) are connected to a set of solenoid valves in communication with the control panel or control center (22) to activate/deactivate said hydraulic systems.

The test bench (5) that includes a lifting assembly (24) operates as follows: the brake (6) to be evaluated is installed on the test bench (5), connecting the arm (63) of the brake (6) to the upper end (811) of the pendulum arm (81), behind the brake (6), and a plurality of sensors are installed on the brake (6) and pendulum arm to measure, in real time, at least the pressure in brake chambers (6), the temperature of the fluid in the brake chambers (6), and the angular velocity and acceleration of the pendulum (8) and arm (63) of the brake (6). Then the pendulum (8), with the mass (83) is brought to a desired or required inclination for the test, for example, from a position (A) to a position (B), as shown schematically in FIG. 4A, by actuating the hydraulic system in the lifting assembly (24), said inclination being defined by the plurality of openings (811e) on the outer side (811d) of the upper end (811) of the pendulum arm (81); When the desired or required inclination is reached, the position of the pendulum (8) is secured by placing the insurance device (9) in the corresponding opening of the plurality of openings (811e), blocking the movement of the pendulum (8); To start the test, the insurance device (9) is removed from the corresponding opening, generating the potential energy stored due to the inclination of the mass (83) to be transformed into kinetic energy, initiating the rotation or rotational movement of the axis of the brake (62) of the brake (6), through the arm (63) of the brake (6), emulating the movement of the bucket door during its opening and/or closing. Finally, the measurements made by the plurality of sensors are transmitted to a control panel or control center (22) for processing and recording. The measurements can be stored as a data sheet or reported in real time or at the end of a test or braking cycle either through a screen on or connected to the control center (22) or through a voucher printed by the control center. control (22).

Once the position of the pendulum (8) is secured with the insurance device (9), the hydraulic system of the lifting assembly (24) is disconnected so that it returns to its initial position in the structure (241) of the assembly. lifting (24).

In one embodiment, the mass (83) is brought to a desired or required inclination for the test by the hydraulic cylinders (242) of the hydraulic system of the lifting assembly (24), being actuated to vertically move the respective stem eyes (244).) to contact the pendulum (8) to raise the mass (83) so that said hydraulic cylinders (242) descend in alignment to contact the pendulum (8) and raise the mass (83), for example, from a position (A) to a position (B). Then, once the position of the pendulum (8) is secured using the latch (91), the hydraulic system is disconnected so that the hydraulic cylinders move vertically until they return to a retracted position.

The position of the pendulum (8) is ensured by placing the latch (91) of the insurance device (9) in the corresponding opening of the plurality of openings (811e), being actuated by the hydraulic system (92) of the insurance device (9).). Likewise, to remove the insurance device (9) and start the test, the hydraulic system (92) is activated to remove the latch (91) and start the movement of the pendulum (8), transforming the potential energy into kinetic energy by rotating the brake shaft (62) of the brake (6), through the arm (63) of the brake (6), emulating the movement of the bucket door during its opening and/or closing. The braking test or cycle ends when the brake (6) dissipates the energy released by the pendulum (8). To perform another braking test or cycle, the same procedure described above must be carried out.

The test bench (5) may further comprise an automated control system incorporated into the control panel or control center (22) so that an operator can configure the test bench (5) to program and perform a quantity of predefined braking tests or cycles under one or more configurations of the mass (83) that establishes the initial condition of potential energy storage, depending on the inclination of the pendulum (8), to evaluate the brake (6) at different conditions. Operating mode also allows the hydraulic systems of the insurance device (9) and the lifting assembly (24) to be activated. The control panel or control center (22) allows you to verify that the test bench sensors (5) are operating correctly.

To adequately simulate or reproduce the operating conditions of a brake (6) installed on bucket doors, the particular configuration of brakes (6) on said door must be considered, so that the mass (83) appropriately represents the load. to which a brake (6) is subjected so that, in one embodiment, the mass (83) corresponds to a part of the total mass of the door to which said brake (6) would be connected. The total mass of the bucket door will be divided by the number of brakes (6) that are installed on the bucket.

1. A test bench (5) to evaluate the operation of a brake (6) or shock absorber for bucket doors of excavators or electric shovels that allows simulating real operating conditions of the bucket doors, wherein it comprises:
a brake support (7) that allows installing and fixing the brake (6) to be evaluated, said brake (6) comprising a body (61) with an axis (62) that is connected to the end of an arm (63) of pivoting shape and its other end is used for connection with the bucket door;
a pendulum (8) to simulate the loads received by the brake (6) due to the opening and/or closing movement of the bucket door, comprising:
a pendulum arm (81) comprising an upper end (81) with a side edge (811a) comprising at least one opening (811b) for fixedly connecting to the free end of the arm (63) of the brake (6), to represent an installation configuration of the brake (6) on the bucket door; an inner side (811c) pivotally connected to a pendulum support (82), by means of a shaft (821), arranged behind the brake support (7), allowing rotational movement of the pendulum (8); and an outer side (811d) comprising a plurality of openings (811e) that define a predefined inclination of the pendulum (8) with respect to a horizontal surface; and
a lower end (812) comprising a known mass (83), interchangeable, representing the load due to the weight of the bucket door;
a safety device (9), arranged in the same plane as the brake support (7) and the pendulum support (82), on one side of the upper end (811) of the pendulum arm (81), which engages in an opening of the plurality of openings (811e) on the outer side (811d) of the pendulum arm (81), to set an inclination position of the pendulum arm (81), which defines an initial potential energy storage condition, by being placed in an opening of the plurality of openings (811e);
a support structure (10), on which the rest of the elements of said test bench (5) are installed or arranged, being formed by beams that define a support or vertical legs that support the components of the test bench (5), and horizontal supports on which the brake support (7), the pendulum support (82) and the insurance device (9) are arranged, where the horizontal supports have an open section that allows the rotational movement of the pendulum (8); and
a plurality of sensors that allow obtaining measurements, in real time, of at least the pressure in the brake chambers (6), the temperature of the fluid in the brake chambers (6), and the angular velocity and acceleration of the pendulum (8) and arm (63) of the brake (6).

2. The test bench (5) according to claim 1, wherein the plurality of sensors are in communication with a control panel or control center (22) to proceed and record the measurements made and display the corresponding values in real time.

3. The test bench (5) according to claim 2, wherein the horizontal supports comprise a first horizontal support (103) that supports the brake support (7) and the pendulum support (82), and include an open section which allows the rotational movement of the pendulum (8); and a second horizontal support (104) projecting from a side of the first horizontal support (103) to support the locking device (9), and the vertical support comprises a first vertical support (101) that is connected to and supports the first horizontal support (103) on which the brake support (7) and the pendulum support (82) are arranged; and a second vertical support (102) that is located on one side of the first vertical support (101), being connected to the second horizontal support (104).

4. The test bench (5) according to claim 2, wherein the upper end (811) of the pendulum arm (81) has the shape of a circumference section where the lateral edge (811a) corresponds to a radius of the circumference section that includes a flange that comprises at least one opening (811b), the inner side (811c) is defined by the joining area of the radii of the circumference section, where a circular opening is included to place the axis (821) of the pendulum support (82) and pivotally connect said upper end (811) with said pendulum support allowing the rotational movement of the pendulum (8), and the outer side (811d) corresponds to the arc of the section of circumference wherein the plurality of openings (811e) are regularly separated from each other by an equiangular distance near the arc of the circumference section.

5. The test bench (5) according to claim 2, wherein the lower end (812) of the pendulum arm (81) comprises a first perforation in which a bar (812a) is arranged, the ends of which protrude from each side of said lower end (812), to place the mass (83) that represents the load due to the weight of the bucket door; and an adjustable lock (812b) at each end of the bar to secure the position of the mass (83).

6. The test bench (5) according to claim 5, wherein the lower end (812) comprises a second perforation (812c) to connect with an auxiliary lifting system, to position the pendulum (8) up to a specific inclination.

7. The test bench (5) according to claim 2, wherein the plurality of sensors comprises:
at least one accelerometer (11) mounting on the arm (63) of the brake (6), which includes an angle inclinometer, gyroscope and magnetometer to measure the acceleration, angular velocity and position of the arm (63) of the brake (6);
a pressure transducer (12), mounted on test manifolds (13) arranged in the body (61) of the brake (6), to measure the gauge pressure in the interior chambers of the body (61) of the brake (6);
at least one temperature sensor (14) mounted on each test manifold (13) and on the back of the body (61) of the brake (6) to measure the temperature in the fluid in the chambers of said body (61); and
at least one pendulum inclination sensor mounted on the pendulum (8) to measure the acceleration, angular velocity and position of the pendulum (8) or the pendulum arm (81).

8. The test bench (5) according to claim 7, wherein the at least one pendulum inclination sensor corresponds to at least one accelerometer (11) mounted on the pendulum arm (81), which includes an inclinometer angle sensor, gyroscope and magnetometer to measure the acceleration, angular velocity and position of the pendulum arm (81), a pendulum position sensor (15), mounted on a support (16) fixed to the pendulum support (82) that records the position of the pendulum (8), or a combination of these.

9. The test bench (5) according to claim 8, wherein the pendulum position sensor (15) is a Hall effect sensor that uses a coded disk (27) mounted on the axis (821) of the pendulum support (82), which comprises an optical pattern that is electronically decoded to generate position information of the pendulum (8) to determine the acceleration, angular velocity and position of the pendulum (8).

10. The test bench (5) according to claim 7, wherein the plurality of sensors further comprises two pendulum inclination sensors (17) mounted, each, on a support (18) fixed to the device. insurance (9) that registers the inclination of the pendulum (8) based on proximity switches placed in the plurality of openings (811e) on the outer side (811d) of the upper end (811) of the pendulum arm (81) to determine the position of each opening of the plurality of openings (811e) so that the locking device (9) is securely engaged to fix the position of the pendulum (8) and the mass (83) at the desired or required inclination.

11. The test bench (5) according to claim 2, wherein it comprises a lifting assembly (24) to raise the mass (83), arranged in the rear part of the support structure (10), in the vertical support, behind the brake support (7) and the pendulum support (82), comprising:
a structure (241) formed by beams that form a frame that extends vertically on the vertical support;
a hydraulic system supported vertically on the structure (241) comprising at least one hydraulic cylinder (242) that descends to come into contact with the pendulum (8) and raise the mass (83) to a required inclination;
a guide (243) arranged in the lower part of the structure (241), where the at least one hydraulic cylinder (242) moves to follow the path of the pendulum (8) when it is inclined; and
a shaft (248) that is connected to the eye of the rod (244) of the at least one hydraulic cylinder (242).

12. The test bench (5) according to claim 11, wherein the pendulum further comprises an extension (811f) that projects from its outer side (811d) that comprises a crescent connection (811g) that is adjusts to the shape of the eye of the stem (244) of at least one hydraulic cylinder (242) or the shaft (248), so that the hydraulic system of the lifting assembly (24) can raise the mass (83) when said eye of the stem (244) engages the crescent connection (811g) as it moves vertically downward.

13. The test bench (5) according to claim 11, wherein the hydraulic system is controlled by a button panel (245) that allows activating/deactivating the at least one hydraulic cylinder (242) to contact the pendulum (8) and raise the mass (83) or remove said at least one hydraulic cylinder (242) from the pendulum (8) to return to its initial position.

14. The test bench (5) according to claim 11, wherein the lifting assembly (24) also comprises a cylinder stroke sensor (25), for each at least one hydraulic cylinder (242) of the hydraulic system, to determine the position and stroke end of each hydraulic cylinder (242) of the hydraulic system of the lifting assembly (24).

15. The test bench (5) according to claim 14, wherein the cylinder stroke sensor (25) is arranged at the end of a support (26) fixed or attached to the structure (241) of the lifting assembly (24) so that the cylinder stroke sensor (25) points to the eye of the rod (244) of the respective hydraulic cylinder (242), being at a height in the structure (241) so that the cylinder stroke sensor (25) is close to the rear of the eye of the rod (244) when the respective hydraulic cylinder (242) is in a retracted or contracted position.

16. The test bench (5) according to claim 2, wherein it comprises an automated control system incorporated into the control center (22) so that an operator can configure the test bench (5) to program and perform a predefined number of tests or braking cycles under one or more configurations of the mass (83) that establishes the initial condition of potential energy storage, depending on the inclination of the pendulum (8), to evaluate the brake (6) to different operating conditions.

17. A procedure to carry out a test to evaluate the operation of a brake (6) or shock absorber for bucket doors of excavators or electric shovels that allows simulating real operating conditions of the bucket doors, wherein the procedure comprising the stages of:
i. install the brake (6), said brake (6) comprising a body (61) with an axis (62) that is connected to the end of an arm (63) in a pivotal manner and its other end is used for its connection with the bucket door, on a brake support (7);
ii. connect the arm (63) of the brake (6) to the upper end (811) of the pendulum arm (81) of a pendulum (8) connecting pivotally, on an inner side (811c) of the pendulum arm (81), with a pendulum support (82) arranged after the brake support (7);
iii. install a plurality of sensors in the brake (6) and pendulum arm (81) to measure, in real time, at least the pressure in the brake chambers (6), the temperature of the fluid in the brake chambers (6), and the angular velocity and acceleration of the pendulum (8) and arm (63) of the brake (6);
iv. place a mass (83) at the lower end (812) of the pendulum arm (81) that represents the load due to the weight of the bucket door that receives the brake (6);
v. raise the mass (83), tilting the pendulum (8) to a desired or required inclination for the test, said inclination being defined by an opening of a plurality of openings (811e) on the outer side (811d) of the upper end (811) of the pendulum arm (81);
vi. ensuring the inclination of the pendulum (8) by placing a safety device (9) in the corresponding opening of the plurality of openings (811e), blocking the movement of the pendulum (8);
vii. remove the insurance device (9) from the corresponding opening of the plurality of openings (811e) to start the test, generating the potential energy stored due to the inclination of the mass (83) to be transformed into kinetic energy, initiating the rotation or rotational movement of the brake shaft (62) of the brake (6), through the arm (63) of the brake (6), emulating the movement of the bucket door during its opening and/or closing.

18. The procedure according to claim 17, wherein the pendulum (8) is brought to the desired inclination by means of a lifting system.

19. The procedure according to claim 17, wherein the pendulum (8) is brought to the desired inclination by activating a lifting assembly (24), arranged after the brake support (7) and the pendulum support (82), understanding:
a structure (241) formed by beams that form a frame that extends vertically;
a hydraulic system supported vertically on the structure (241) comprising at least one hydraulic cylinder (242) that descends to come into contact with the pendulum (8) and raise the mass (83) to a required inclination;
a guide (243) arranged in the lower part of the structure (241), where the at least one hydraulic cylinder (242) moves to follow the path of the pendulum (8) when it is inclined; and
a shaft (248) that is connected to the eye of the rod (244) of the at least one hydraulic cylinder (242).

20. The procedure according to claim 17, wherein it is installed:
at least one accelerometer (11) mounting on the arm (63) of the brake (6), which includes an angle inclinometer, gyroscope and magnetometer to measure the acceleration, angular velocity and position of the arm (63) of the brake (6);
a pressure transducer (12), mounted on test manifolds (13) arranged in the body (61) of the brake (6), to measure the gauge pressure in the interior chambers of the body (61) of the brake (6);
at least one temperature sensor (14) mounted on each test manifold (13) and on the back of the body (61) of the brake (6) to measure the temperature in the fluid in the chambers of said body (61); and
at least one pendulum inclination sensor mounted on the pendulum (8) to measure the acceleration, angular velocity and position of the pendulum (8) or the pendulum arm (81).
